(19) United States
(12) Patent Application Publication
(10) Pub. No.: US 2006/0227752 A1
(43) Pub. Date: Oct. 12, 2006

(54) Packet transmission method and apparatus

(76) Inventor: Toshiyuki Sashihara, Tokyo (JP)

Correspondence Address: SCULLY SCOTT MURPHY & PRESSER, PC, 400 GARDEN CITY PLAZA, SUITE 300, GARDEN CITY, NY, 11530, US

(21) Appl. No.: 11/375,164

(22) Filed: Mar. 14, 2006

(30) Foreign Application Priority Data
Mar. 16, 2005 (JP) 2005-075157

(51) Int. Cl. H04Q 7/24

(52) U.S. Cl. 370/338; 370/465

(57) ABSTRACT

When voice, video, and other communications requiring real-time processability are carried out using wireless packet communications in a wireless LAN etc., a technique is used, in which a plurality of packets are encapsulated in order to reduce the proportion occupied by the header relative to the entire frame. Because in the past packets were encapsulated without considering transmission rates used for data transmission between the base station and the terminals, all the packets had to be transmitted at the lowest transmission rate, which was inefficient. According to the present invention, not only are packets sorted based on whether they should be encapsulated or not, but, in addition, packets to be encapsulated are sorted according to the transmission rates, at which the terminals can communicate with the base station, and then encapsulated and transmitted at said transmission rates.

### BACKGROUND OF THE INVENTION

1. Field of the Invention

The present invention relates to wireless packet communications in wireless LANs (Local Area Networks) etc. In particular, the present invention relates to improvements in the efficiency of real-time communications of voice, video and the like.

2. Description of Related Art

When voice, video, and other information requiring real-time processability is transmitted using wireless packet communications in a wireless LAN, etc., the size of the data stored in each wireless frame is small, resulting in an increased proportion occupied by the header relative to the entire frame. Moreover, in case of a wireless LAN, as defined in IEEE 802.11, the header portion is transmitted at the lowest transmission rate, and, consequently, the proportion of time occupied by the transmission of the header becomes larger than the proportion used for the bit length, thus rendering impossible efficient use of the original transmission speed.

As a method to solve this problem, Patent Document 1 discloses sorting receive packets into QoS (Quality of Service) packets and other, general packets, and then encapsulating the QoS packets and transmitting them in accordance with the CODEC cycle.

FIG. 11 is a block diagram of a packet transmission apparatus, as described in Patent Document 1. The packet transmission apparatus is composed of a base station 1020 and terminals 1031-103N, with the base station 1020 made up of a packet receiving section 1101, a packet sorting section 1102, a general packet FIFO queue buffer 1104, QoS packet FIFO queue buffers 1105, a packet synthesis section 1106, an interval timer 1107, a wireless packet transmitting section 1108, a wireless packet receiving section 1130, a packet restoration section 1131, and a packet transmitting section 1132. In turn, the terminals 1031-103N are made up a wireless packet receiving section 1111, a packet restoration section 1112, applications 1120, a packet transfer section 1122, a QoS queue 1123, a general queue 1124, an interval timer 1125, a packet synthesis section 1126, and a wireless packet transmitting section 1127.

Next, operation that takes place when the base station 1020 receives data for terminals 1031-103N from the wired zone is explained with reference to FIG. 11. When the base station 1020 receives data for terminals 1031-103N from the wired zone through the packet receiving section 1101, the data is sent to the packet sorting section 1102. The packet sorting section 1102 checks whether the received data is to be encapsulated or not, with data to be encapsulated stored in the QoS queue 1123 and data that does not have to be encapsulated stored in the general queue 1124. The sorting of data to be encapsulated and data that does not have to be encapsulated is carried out based on (1) the contents of the data (voice or video), (2) protocols (TCP or UDP) and IP port numbers, and (3) MAC addresses. Data accumulated in queues is encapsulated in a single frame at each timing interval calculated by the interval timer 1107 and is transmitted using a broadcast or multicast frame by a method that requires no ACK response. By doing so, the overhead of the header is reduced.

Incidentally, in the technology described in Patent Document 1, packet sorting makes no allowance for transmission rates used between the base station and the terminals. Under the IEEE 802.11b standard, there are four types of rates defined as transmission rates utilized for data transmission between a base station and terminals in a wireless LAN, namely, 1, 2, 5.5, and 11 Mbps. The communications environment between the individual terminals and the base station determines which transmission rate is used. In the technology described in Patent Document 1, data is encapsulated in the QoS queue without taking transmission rates into account, such that an encapsulated frame may contain a mix of packets destined for terminals connected at 1 Mbps and packets destined for terminals connected at 11 Mbps. Therefore, to be correctly received on all the terminals, encapsulated frames have to be sent at the lowest transmission rate. This is extremely inefficient because frames end up being transmitted at 1 Mbps, i.e. the lowest transmission rate, even to terminals capable of transmission at 11 Mbps.

### SUMMARY OF THE INVENTION

The present invention was made with account taken of the above-described problems, and it is an object of the invention to offer a method, and an apparatus, that permit efficient transmission of short-length data, such as voice data etc., even when transmission rates used for connection to a base station are different for each individual terminal.

To eliminate the above-described problems, the present invention provides a packet transmission method consisting in bundling together, i.e. encapsulating, a plurality of voice or other small-sized packets and transmitting the same to a plurality of destinations, wherein either of a plurality of transmission rates is configured individually for the plurality of destinations, and, for each respective rate of the plurality of transmission rates, packets intended for one or for a plurality of destinations, for which the rate is configured, are bundled together.

In order to bundle packets by transmission rate, beneficially, the packets to be transmitted are subsequently sorted by the timing, at which the bundled packets are transmitted.

Beneficially, information regarding the transmission rates used for a destination is acquired through means used for communication with the destination.

If the destination is a wireless terminal, the reception field strength of the destination is checked, and if the reception field strength is at the threshold value, at which the transmission rate changes, the transmission rate is changed. In such a case, for packets transmitted to destinations whose transmission rate may change, bundling is preferably carried out using both the current transmission rate and the transmission rate, to which it may change.

For a particular transmission rate, whenever the time required for transmission is shortened by bundling and transmitting together with packets of another transmission rate rather than by bundling and transmitting using this particular rate, bundling and transmission are preferably carried out using the other transmission rate.

In the packet transmission apparatus of the present invention, which is equipped with means for bundling multiple small-sized packets together and means for transmitting the bundled packets to a plurality of destinations, either of a plurality of transmission rates is configured individually for the plurality of destinations, and there is provided means for sorting the packets such that, for each respective rate of the plurality of transmission rates, packets intended for one or for a plurality of destinations, for which the rate is configured, are bundled together.

Beneficially, the sorting means then sorts the packets to be transmitted according to the timing of transmission from the transmitting means.

Beneficially, information regarding transmission rates for a destination is acquired through means used for transmitting to the destination.

When the destination is a wireless terminal, the reception field strength of the destination is checked, and if the reception field strength is at the threshold value at which the transmission rate changes, the transmission rate is changed. In such a case, with respect to packets transmitted to destinations whose transmission rate may change, the sorting means can perform sorting both by the current transmission rate and by the transmission rate, to which it may change.

With respect to a packet, for which the time required for transmission is shortened by bundling and transmitting it together with packets of another transmission rate rather than bundling and transmitting it using its own particular rate, the sorting means can perform sorting in such a manner that they are bundled by the other transmission rate.

The packet transmission apparatus can be used as a packet transmission means for an access point performing communication with wireless local area network terminals.

According to the present invention, voice and other small-sized packets can be sorted by transmission rate and can be transmitted at a high transmission rate to destinations capable of communication at such a transmission rate. The effects produced by doing so include the ability to increase the maximum number of simultaneous calls, shorten the time during which the wireless communication medium is occupied, and transmit VoIP data and other data with a short data length in a more efficient manner.

### BRIEF DESCRIPTION OF THE DRAWINGS

Specific embodiments of the present invention will now be described, by way of example only, with reference to the accompanying drawings in which:

FIG. 1 illustrates an example of an embodiment of the present invention.

FIG. 2, which is a block diagram illustrating a first embodiment of the present invention, illustrates an example, wherein the packet transmission apparatus of the present invention is implemented as an access point.

FIG. 3 is a flow chart illustrating an example of packet sorting.

FIG. 4 is a flow chart illustrating an example of encapsulation.

FIG. 5 is a flow chart illustrating an example of processing associated with a transmission rate query in the transmission rate monitoring section.

FIG. 6 is a flow chart illustrating an example of operation of the wireless LAN frame transceiver section.

FIG. 7 is a diagram explaining packet encapsulation in the encapsulation section.

FIG. 8 is a block diagram illustrating a second embodiment of the present invention.

FIG. 9 is a flow chart illustrating an example of operation of the specified rate packet extraction section.

FIG. 10 is a flow chart illustrating an example of operation of the wireless LAN frame transceiver section in a third embodiment.

FIG. 11 is a block diagram of a prior art example.

### DETAILED DESCRIPTION OF THE PREFERRED EMBODIMENTS

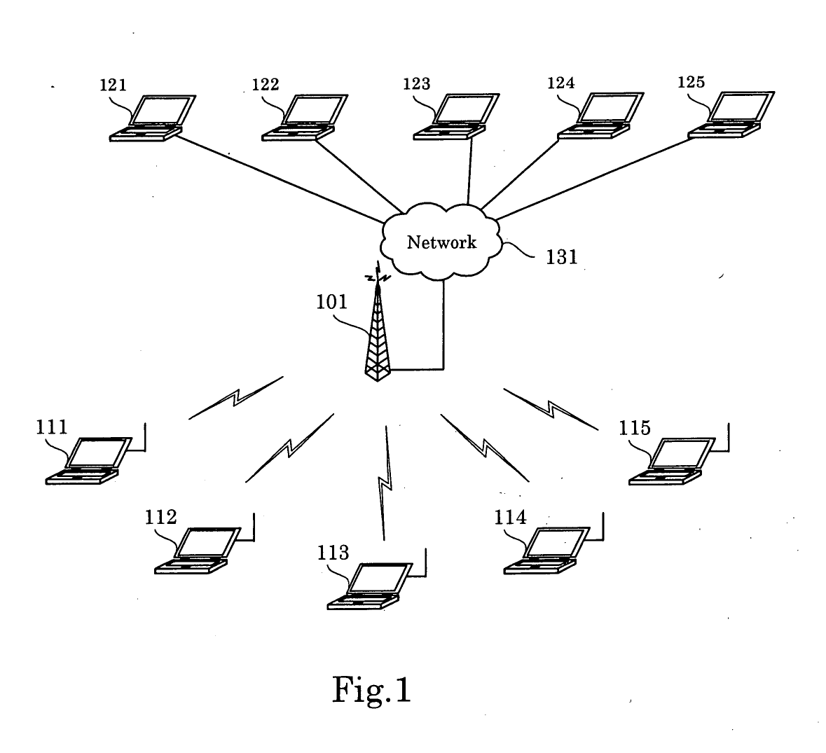

As an example of an embodiment of the present invention, FIG. 1 illustrates an exemplary configuration, in which the present invention is implemented in a wireless LAN. Here, the invention is illustrated with reference to a wireless LAN, as defined by IEEE 802.11.

The wireless LAN is made up of an access point 101, wireless LAN terminals 111-115, terminals 121-125 connected via a cable network, and a network 131. In addition to the functionality inherent to wireless LAN terminals and an access point, as defined under IEEE 802.11, the wireless LAN terminals 111-115 and the access point 101 also possess features described in the present invention. Terminals 121-125 serve as correspondents of the wireless LAN terminals. The network 131 is a network such as Ethernet (registered trademark), etc. The wireless LAN terminals 111-115 and terminals 121-125 are presumed to carry out voice-communications using the VoIP (Voice Over IP) protocol.

Communications between the wireless LAN terminals 111-115 and the terminals 121-125 are explained herein with particular focus on packet transmission from the terminals 121-125 to the wireless LAN terminals 111-115.

Communications from the terminals 121-125 to the wireless LAN terminals 111-115 are carried out through the network 131 and the access point 101. The access point 101 encapsulates a plurality of small-sized voice and other packets and transmits them to the wireless LAN terminals 111-115. Either of a plurality of transmission rates is configured individually for communication between the access point 101 and the wireless LAN terminals 111-115, and, for each of the plurality of transmission rates, the access point 101 encapsulates and transmits packets to one or a plurality of wireless LAN terminals, for which the rate is configured. The respective wireless LAN terminals 111-115 receive packets encapsulated using transmission rates configured for them and extract packets addressed to them.

### First Embodiment

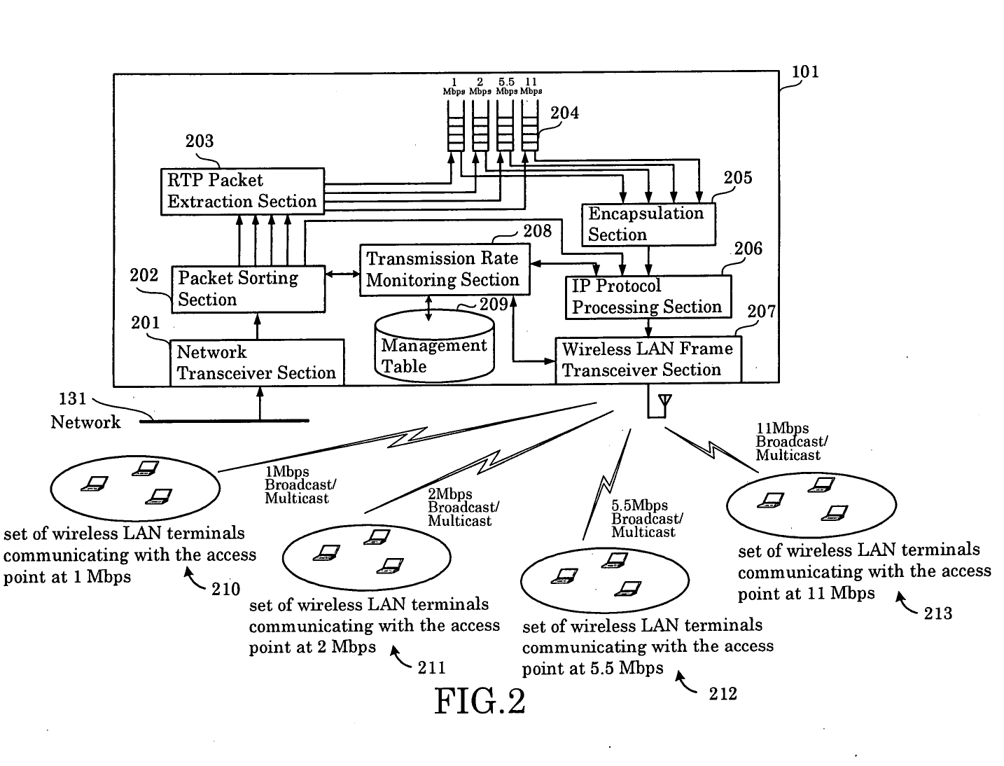

FIG. 2, which is a block diagram illustrating a first embodiment of the present invention, illustrates an example, in which the packet transmission apparatus of the present invention is implemented as the access point 101 shown in FIG. 1.

The access point 101 is made up of a network transceiver section 201, a packet sorting section 202, an RTP (Real-time Transport Protocol) packet extraction section 203, encapsulated packet queues 204, an encapsulation section 205, an IP protocol processing section 206, a wireless LAN frame transceiver section 207, a transmission rate monitoring section 208, and a management table 209.

The network transceiver section 201, which is a protocol processing means located in the physical and data link layer of the OSI 7 layer model, receives data from the network 131 and transmits data to the network 131.

In addition to IP protocol stack processing, the packet sorting section 202, which is located in the network layer of the OSI 7 layer model, analyzes the contents of the IP headers of the received packets and sorts them according to whether the packets are to be encapsulated or not, as well as uses information from the transmission rate monitoring section 208 to classify the contents of the packets already classified according to encapsulation requirements into four categories, i.e. 1 Mbps, 2 Mbps, 5.5 Mbps, and 11 Mbps.

The RTP packet extraction section 203, which is located above the network layer of the OSI 7 layer model, extracts RTP headers and payloads from the encapsulated packets (VoIP packets in the present embodiment). During extraction, it extracts source addresses, destination addresses, source port numbers, and destination port numbers stored in the IP headers of the IP packets, in which the RTP packets are stored, and stores them in the encapsulated packet queues 204 by pairing with the extracted RTP packets.

The encapsulated packet queues 204 are used to store data designated as subject to encapsulation by the packet sorting section 202.

The encapsulation section 205, which is located above the network layer of the OSI 7 layer model, groups the RTP packets stored in the encapsulated packet queues 204 by destinations connected at the same rate and passes them on to the IP protocol processing section 206.

The IP protocol processing section 206, which is located in the network layer of the OSI 7 layer model, is a means for IP protocol processing.

The wireless LAN frame transceiver section 207 transmits data passed on from the IP protocol processing section 206 and corresponds to the MAC layer and physical layer of the wireless LAN.

The transmission rate monitoring section 208 acquires transmission rates for each terminal from the wireless LAN frame transceiver section 207, registers them in the management table 209, and, in case of queries about transmission rates from the packet sorting section 202, responds to such queries.

Next, the operation of the present embodiment is explained with reference to FIGS. 2 to 7.

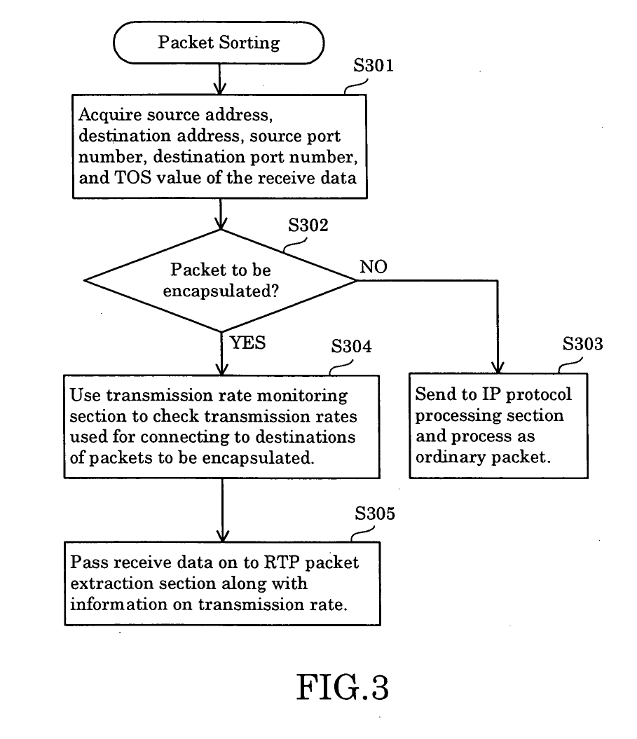

First of all, when the network transceiver section 201 receives data from the network 131, the data is sent to the packet sorting section 202. Operation that takes place when the packet sorting section 202 receives the data is explained by referring to the flow chart of FIG. 3.

When the packet sorting section 202 receives the data, it refers to the header of the IP packet of the receive data and acquires the source address, destination address, source port number, destination port number, and TOS (Type of Service) of the receive data (S301).

Next, based on this information, it is determined whether the IP packet should be encapsulated (S302). To determine whether it should be encapsulated, the source addresses, destination addresses, destination port numbers, source port numbers, and TOS values subject to encapsulation need to be configured in advance. For instance, in the present embodiment, it is assumed that, in order to encapsulate VoIP packets, a value appropriate for voice traffic has been configured as the TOS as a pre-condition for encapsulation.

If the data is not to be encapsulated, the data is sent to the IP protocol processing section 206 and processed as an ordinary packet (S303). If the packet is to be encapsulated, the destination address is conveyed to the transmission rate monitoring section 208 to check the transmission rates at which terminals possessing the destination address are connected (S304). If the transmission rate is determined, the receive data is passed on to the RTP packet extraction section along with transmission rate information (S305).

The RTP packet extraction section 203 extracts the source IP addresses, destination IP addresses, source port numbers, and destination port numbers from the IP headers of the receive data, obtains the RTP packets, from which the IP headers and UDP headers have been eliminated, and stores the source IP addresses, destination IP addresses, source port numbers, destination port numbers, and the RTP packets in the encapsulated packet queues 204 corresponding to the transmission rates provided by the packet sorting section 202. When the appropriate time arrives, the encapsulation section 206 encapsulates data stored for particular rates in the encapsulated packet queues 204.

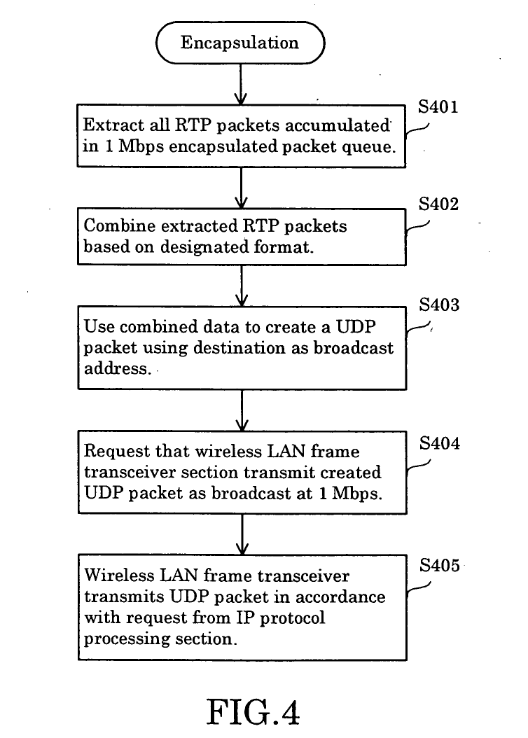

FIG. 4 shows a process flow used for encapsulation, in particular, for encapsulation of data in the 1 Mbps encapsulated packet queue.

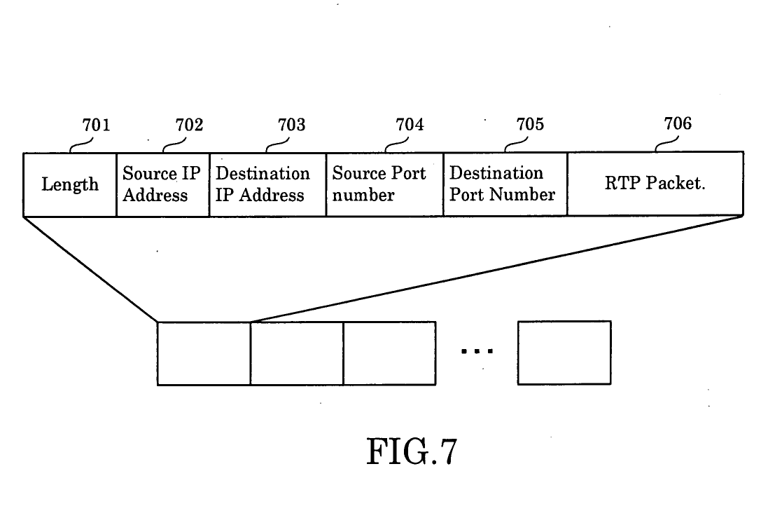

Here, first of all, all the RTP packets accumulated in the 1 Mbps encapsulated packet queue are extracted (S401). Next, the extracted RTP packets are combined according to their format, e.g. as shown in FIG. 7 (S402). In other words, the source IP address 702, the destination IP address 703, the source port number 704, and the destination port number 705 of the RTP packet 706, and, in addition, the length information 701 are appended to the extracted RTP packet 706, bundling a plurality thereof. The length information 701 contains its own length.

The encapsulation section 205 passes the combined data and the data rate on to the IP protocol processing section 206, creating a UDP packet using the destination as a broadcast address (S403). In case of a general socket interface, the use of the sendto function is sufficient to pass data combined in the created socket on to the broadcast address, and data rate specification can be implemented, for instance, if the configuration options specified in the argument of the setsockopt function are expanded.

Next, the IP protocol processing section 206 requests that the wireless LAN frame transceiver section transmit the created UDP packet as a broadcast at the specified data rate (S404). Based on the request from the IP protocol processing section (206), the wireless LAN frame transceiver section 207 transmits the UDP packet (S405).

Here, explanations have been provided only regarding 1 Mbps, but similar methods are used for other transmission rates as well. Also, an appropriate timing is used for each transmission rate. As far as such appropriate timing is concerned, for instance, if the currently used audio codec generates a packet every 20 msec, the processing is expected to take place periodically every 20 msec.

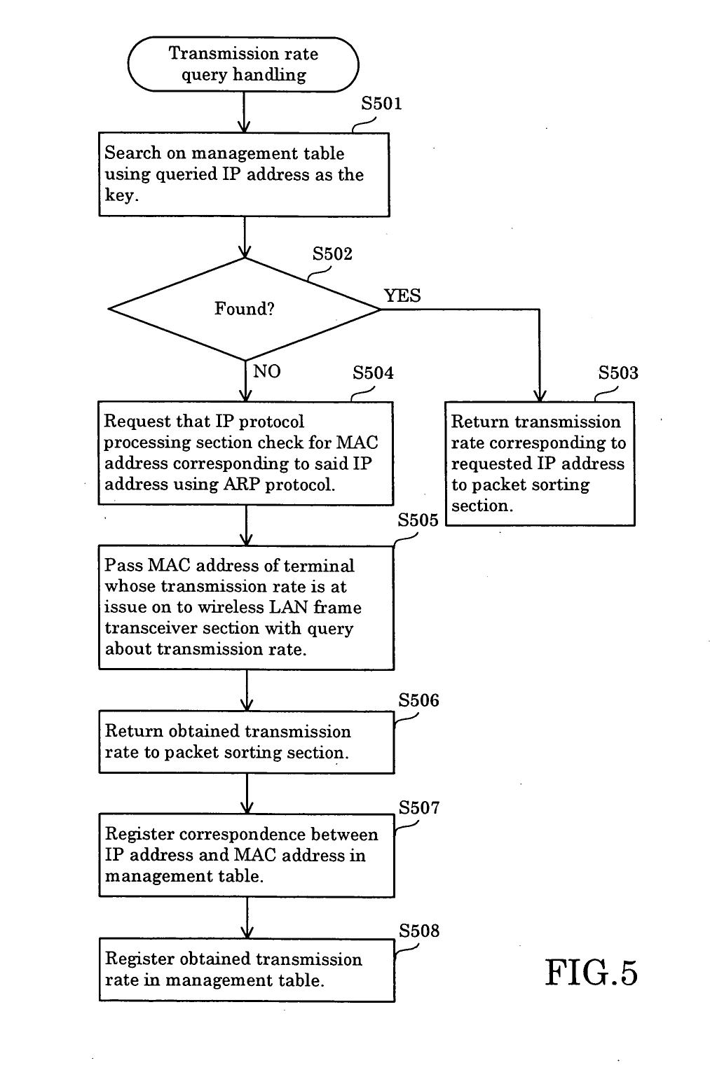

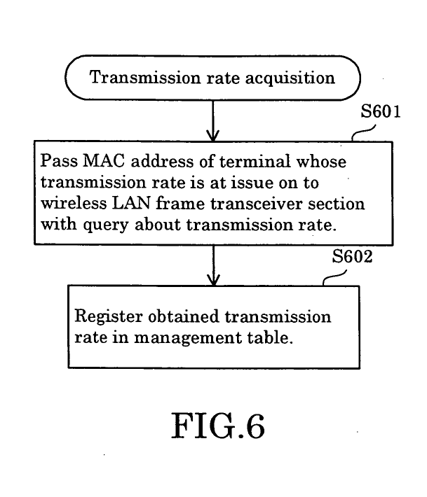

FIG. 5 and FIG. 6 are used to explain the operation of the transmission rate monitoring section 208.

First of all, explanations are provided regarding the handling of queries from the packet sorting section 202. A determination is made as to whether the MAC address corresponding to the IP address queried by the packet sorting section 202 is already known (S501). This is established by searching on the management table 209. If it is found, the transmission rate corresponding to the requested IP address is returned to the packet sorting section 202 (S503).

If it is not found, the IP protocol processing section 206 is requested to check for a MAC address corresponding to the IP address using the ARP protocol (S504). When the MAC address is determined, the MAC address of the terminal whose transmission rate is at issue is passed on to the wireless LAN frame transceiver section 207 with a query about the transmission rate (S505). While this depends on the specifications of the wireless LAN chip, this can be accomplished, for example, by reading values in the register of the wireless LAN chip. After obtaining the transmission rate, the obtained transmission rate is returned to the packet sorting section 202 (S506).

After returning the rate, the correspondence between the IP address and the MAC address is registered in the management table and (S507) and the obtained transmission rate is registered in the management table as well in order to provide for quicker handling of subsequent queries (S508).

Next, FIG. 6 is used to explain operation that takes place during transmission rate acquisition. First of all, the MAC address of a terminal whose transmission rate is at issue is passed on to the wireless LAN frame transceiver section 207 with a query about the transmission rate (S601). After obtaining the transmission rate, the obtained transmission rate is registered in the management table (S602). Such transmission rate acquisition operations are performed periodically, at short intervals, for all the terminals registered in the management table in order to make sure that the latest transmission rates are always available.

Thus, in the present embodiment, not only are packets sorted based on whether or not they should be encapsulated, but, in addition, packets to be encapsulated are sorted according to the transmission rates, at which the terminals can communicate with the base station, and transmission to terminals capable of communication at high transmission rates can be carried out at such high transmission rates, thereby enabling a reduction in the time during which the wireless communication medium is occupied and providing for more efficient transmission of VoIP data and other data of short data length.

### Second Embodiment

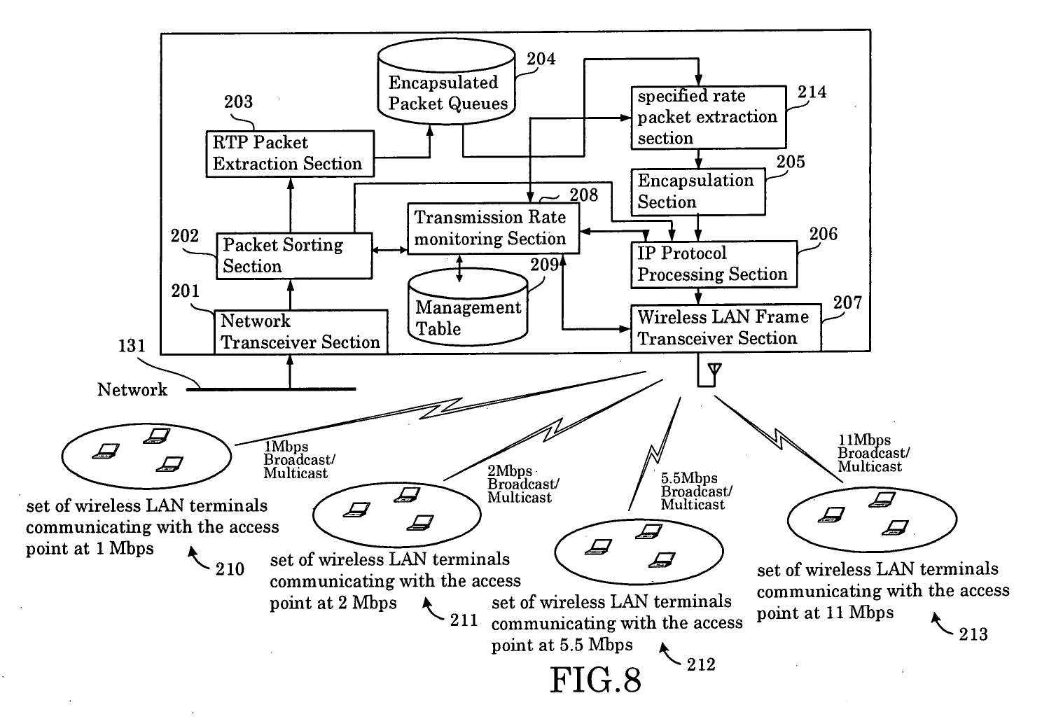

FIG. 8, which is a block diagram illustrating a second embodiment of the present invention, illustrates an example, in which the packet transmission apparatus of the present invention is implemented as an access point 101, in the same manner as in the first embodiment.

The access point 101 is different from the first embodiment in that there is provided a specified rate packet extraction section 214, the packet sorting section 202 does not possess the function of sorting by transmission rate and only sorts packets into packets that should be encapsulated and those that shouldn't, with the encapsulated packet queues 204 storing packets of all transmission rates without pre-processing by transmission rate.

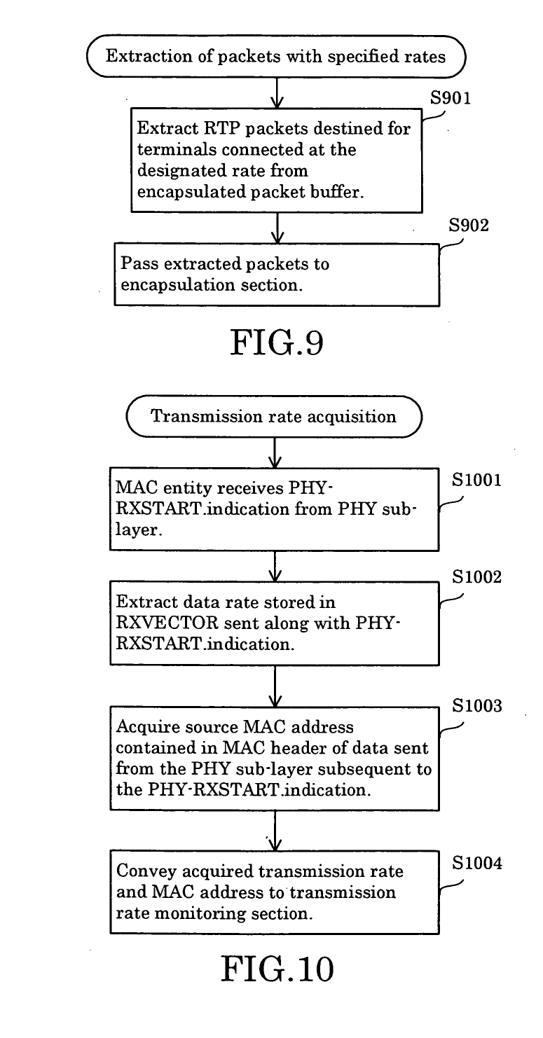

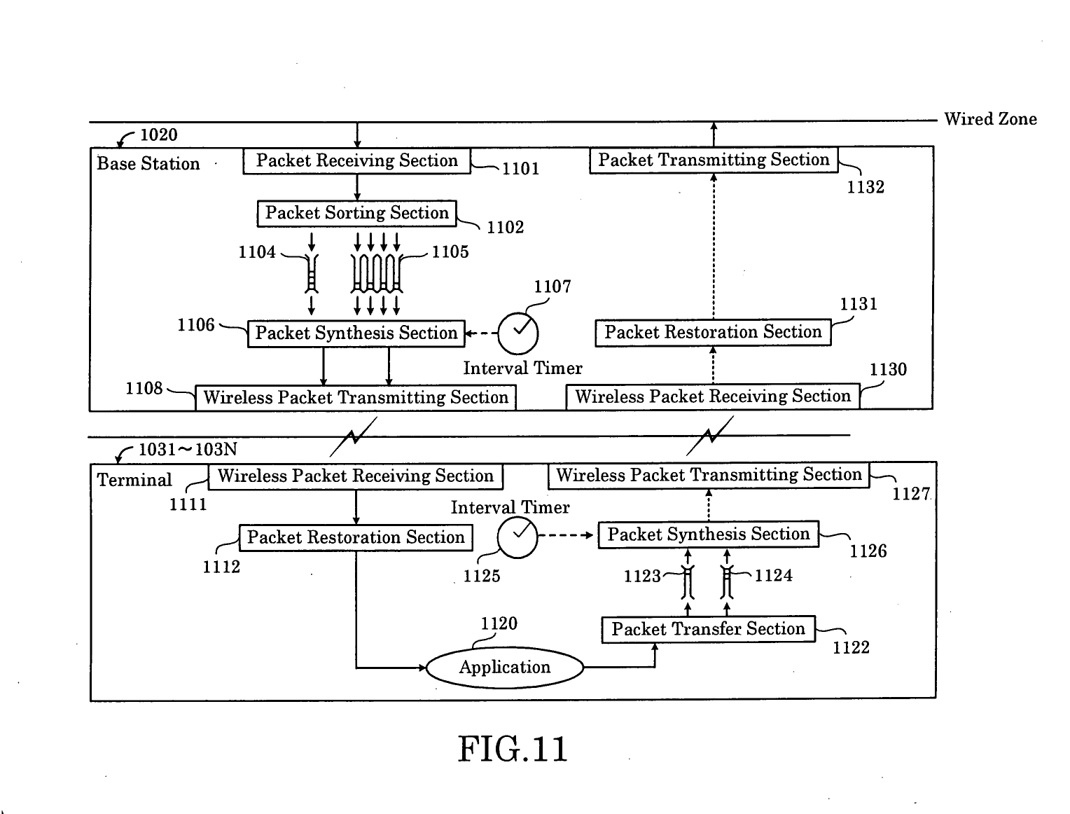

Next, the operation of the present embodiment is explained with reference to the flow chart of FIG. 9. In the present embodiment, the packet sorting section 202 classifies packets into two types only, i.e. packets to be encapsulated and general packets. Receive packets classified as packets to be encapsulated are sent to the RTP packet extraction section 203. Upon extraction of the RTP packets, the RTP packet extraction section 203 stores them in the encapsulated packet queues 204. When the appropriate time arrives, the specified rate packet extraction section 214 uses information from the transmission rate monitoring section 208 to extract only the RTP packets destined for terminals connected at a particular transmission rate from the encapsulated packet queues 204 (S901) and passes them on to the encapsulation section 205 (S902). Subsequent processing is identical to the first embodiment.

Thus, in the present embodiment, the effect of sorting packets by transmission rate in the transmission stage is that it becomes easier to follow changes in the transmission rates of the terminals.

### Third Embodiment

Although the configuration of the present embodiment is similar to the configuration of the first embodiment illustrated in FIG. 2, the method used for the acquisition of terminal transmission rates between the wireless LAN frame transceiver section 207 and transmission rate monitoring section 208 is different. The operation of the wireless LAN frame transceiver section 207 is explained by referring to the flow chart of FIG. 10.

First of all, when the MAC entity in the wireless LAN frame transceiver section 207 receives a PHY-RXSTART.indication from the PHY sub-layer (S1001), the wireless LAN frame transceiver section 207 extracts the data rate stored in the RXVECTOR sent along with the PHY-RXSTART.indication (S1002). Next, the source MAC address contained in the MAC header of the data sent from the PHY sub-layer subsequent to the PHY-RXSTART.indication is acquired (S1003). Upon acquisition of the transmission rate and the MAC address, they are conveyed to the transmission rate monitoring section 208 (S1004).

Thus, in the present embodiment, as a result of updating the transmission rates of the terminals whenever the MAC receives a PHY-RXSTART.indication from the PHY sub-layer, the chances of the packet sorting section 202 mistakenly sorting packets into different transmission rates can be reduced.

### Fourth Embodiment

Although the configuration of the present embodiment is similar to the configuration of the first embodiment illustrated in FIG. 2, the operation of the wireless LAN frame transceiver section 207 and transmission rate monitoring section 208, as well as that of the management table 209 and the packet sorting section 202, are somewhat different.

In addition to acquiring terminal transmission rates from the wireless LAN frame transceiver section 207, the transmission rate monitoring section 208 acquires information on the reception field strength of radio waves emitted by the terminals. After that, the information on the reception field strength, along with IP addresses, MAC addresses, and transmission rates, is stored in the management table 209. Information on the reception field strength is supplied, along with transmission rates, whenever there is a query from the packet sorting section 202 to the transmission rate monitoring section 208. When packets are sorted, the packet sorting section 202 takes the reception field strength into account and, if the reception field strength is near the threshold value at which the transmission rate changes, the packet sorting section 202 stores the packet in the encapsulated packet queues 204, both in the queue corresponding to the current rate and the queue corresponding to the transmission rate, to which it may change.

Thus, in the present embodiment, pre-transmission using both the current transmission rate and the transmission rate, to which it may change, makes it possible to avoid non-reception even if the transmission rate of a terminal changes between the time when a packet is stored in the encapsulated packet queues 204 and its actual transmission. It should be noted that the approach of the present embodiment can be applied to the second embodiment as well. Moreover, the number of the transmission rates expected to change need not be limited to just a single rate, and there may be as many as two or more transmission rates of this kind.

### Fifth Embodiment

Although the configuration of the present embodiment is similar to the configuration of the first embodiment illustrated in FIG. 2, it differs from the first embodiment in that the encapsulation section 205 has a function for checking the number of packets stored in each queue of the encapsulated packet queues 204.

The operation of the present embodiment is explained using a case, in which, prior to encapsulation, packets are extracted from a 2 Mbps transmission rate queue contained in the encapsulated packet queues 204.

During extraction of packets from the 2 Mbps queue, the encapsulation section 205 also checks the size of stored packets and the number of packets in queues of other transmission rates. At such time, if the number of packets in a queue with a rate one-level higher than 2 Mbps, i.e. in the 5.5 Mbps queue, is small, such as one packet, etc., then it is determined by calculation whether it would be more efficient to transmit the 5.5 Mbps packet at 5.5 Mbps or whether it would be better to transmit it at 2 Mbps. Specifically, calculations are performed using the following formulas.
T1=(PLCP preamble length+PCLP header length)/PCLP header transmission rate+(802.11 MAC header length+LLC (Logical Link Control) header length+IP header length+UDP header length+(size of encapsulated 2 Mbps packets)+(size of encapsulated 5.5 Mbps packets))/2 Mbps
T2=(PLCP preamble length+PCLP header length)/PCLP header transmission rate+(802.11 MAC header length+LLC header length+IP header length+UDP header length+(size of encapsulated 2 Mbps packets))/2 Mbps+(PLCP preamble length+PCLP header length)/PCLP header transmission rate+(802.11 MAC header length+LLC header length+IP header length+UDP header length+(size of encapsulated 5.5 Mbps packets))/5.5 Mbps+DIFS

Here, T1 is the time required when transmitting at 2 Mbps, T2 the time required when transmitting at 5.5 Mbps, and the PCLP preambles, PCLP headers, and PLCP header transmission rates are as defined in the IEEE 802.11b specification, corresponding, respectively, to 144 bits, 48 bits, and 1 Mbps when using the long frame format in 802.11b. The DIFS (Distributed Inter Frame Space) is also as defined in the specification, i.e. 50 msec.

After calculating T1 and T2, the next step is to determine which value is smaller. A smaller T1 means that transmitting 5.5 Mbps packets at 2 Mbps will require a shorter time, and in such a case 5.5 Mbps packets are transmitted at 2 Mbps. Conversely, when T2 is smaller, transmitting 5.5 Mbps packets at 2 Mbps increases the required time, and, consequently, only packets stored in the 2 Mbps queue are transmitted in such a case.

In the present embodiment, explanations are provided with regard to handling of packets stored in the 5.5 Mbps queue, which transmission rate is one-level higher, when transmitting packets stored in the 2 Mbps queue, but an inverse pattern exists as well. Namely, during transmission of packets stored in the 2 Mbps queue, when the number of packets stored in the 2 Mbps queue is small, packets stored in the 1 Mbps queue, which has a one-level lower transmission rate, are checked to determine whether the 2 Mbps packets should be transmitted at 1 Mbps or not.

It should be noted that although explanations in this embodiment are provided only with regard to 2 Mbps and the neighboring transmission rates, such checking can be done for combinations with other, non-adjacent, transmission rates. Moreover, the approach of the present embodiment is applicable to the second embodiment as well, and, in such a case, it is sufficient to perform the operation described in the present embodiment in the specified rate packet extraction section 214 of FIG. 8.

Thus, when the number of packets stored in the queue is small, more efficient transmission is made possible by transmitting packets after calculating whether it is better to transmit at this rate or to transmit at a transmission rate lower than the transmission rate of the queue. This is particularly effective when there are numerous types of transmission rates, such as in case of 802.11g and the like.

As explained above, according to the present invention, when receive packets are sorted into encapsulated packets and other packets, the packets subject to encapsulation are further sorted by the transmission rates, at which the terminals are connected, so that during encapsulation packets destined for terminals connected at the same transmission rate are combined and transmitted at said transmission rate, thereby providing for efficient transmission of the encapsulated packets.

What is claimed is:

1. A packet transmission method for bundling a plurality of small-sized packets together and transmitting the same to a plurality of destinations,
wherein either of a plurality of transmission rates is configured individually for the plurality of destinations, and
for each respective rate of the plurality of transmission rates, packets intended for one or for a plurality of destinations, for which the rate is configured, are bundled together.

2. The packet transmission method according to claim 1,
wherein with respect to packets transmitted to destinations whose transmission rate may change, bundling is performed using both the current transmission rate and the transmission rate, to which it may change.

3. The packet transmission method according to claim 1,
wherein for a particular transmission rate, whenever the time required for transmission is shortened by bundling and transmitting together with packets of another transmission rate rather than by bundling and transmitting using said particular rate, bundling and transmission are performed using the other transmission rate.

4. A packet transmission apparatus comprising:
means for bundling a plurality of small-sized packets together, and
means for transmitting the bundled packets to a plurality of destinations,
wherein either of a plurality of transmission rates is configured individually for the plurality of destinations, and there is provided means for sorting the packets such that, for each respective rate of the plurality of transmission rates, packets intended for one or for a plurality of destinations, for which the rate is configured, are bundled together.

5. The packet transmission apparatus according to claim 4,
wherein with respect to packets transmitted to destinations whose transmission rates may change, the sorting means performs sorting both by the current transmission rate and by the transmission rate, to which it may change.

6. The packet transmission apparatus according to claim 4,
wherein with respect to packets, for which the time required for transmission is shortened by bundling and transmitting together with packets of another transmission rate rather than bundling and transmitting using their particular rate, the sorting means performs sorting such that they are bundled by the other transmission rate.

7. The packet transmission apparatus according to claim 4, which can be used as a packet transmission means for an access point performing communication with wireless local area network terminals.
